(19) United States
(12) Patent Application Publication
(10) Pub. No.: US 2016/0241159 A1
(43) Pub. Date: Aug. 18, 2016

(54) RESONANT TYPE HIGH FREQUENCY POWER SUPPLY DEVICE

(71) Applicant: MITSUBISHI ELECTRIC ENGINEERING COMPANY, LIMITED, Chiyoda-ku, Tokyo (JP)

(72) Inventors: Yoshiyuki AKUZAWA, Chiyoda-ku (JP); Kiyohide SAKAI, Chiyoda-ku (JP); Toshihiro EZOE, Chiyoda-ku (JP); Yuki ITO, Chiyoda-ku (JP)

(73) Assignee: MITSUBISHI ELECTRIC ENGINEERING COMPANY, LIMITED, Chiyoda-ku, Tokyo (JP)

(21) Appl. No.: 15/024,564

(22) PCT Filed: Oct. 31, 2013
(86) PCT No.: PCT/JP2013/079552

§ 371 Date: Mar. 24, 2016

(51) Int. Cl. H02M 7/533; H02J 50/12

(52) U.S. Cl. CPC H02M 7/533; H02J 50/12; H02M 2007/4815

(57) ABSTRACT

A resonant type high frequency power supply device provided with a power semiconductor element that performs a switching operation at a high frequency exceeding 2 MHz, the resonant type high frequency power supply device including a resonance matched filter that controls both the waveform of a switching voltage of the power semiconductor element and the waveform of an output voltage.

### FIELD OF THE INVENTION

The present invention relates to a resonant type high frequency power supply device that performs power transmission at a high frequency.

### BACKGROUND OF THE INVENTION

A conventional resonant type high frequency power supply device shown in FIG. 8 is configured in such a way that a condition imposed on the resonant switching of a power element (FET) 101 can be maintained by an inductor 102 and a capacitor 103 which are connected in parallel between the drain and the source of the FET 101 even when the parasitic capacitance 104 of the FET 101 is large.

### RELATED ART DOCUMENT

### Patent Reference

Patent reference 1: Japanese Unexamined Patent Application Publication No. 2013-30973

### SUMMARY OF THE INVENTION

### Problems to be Solved by the Invention

However, because in the conventional technology disclosed in patent reference 1 a setting is made in such away that the condition imposed on the resonant switching can be maintained with respect to the parasitic capacitance 104 of the FET 101, variations in the impedance of the load connected to the output cannot be compensated for. Therefore, a problem is that when an impedance component having a resonance condition, such as an antenna for wireless power transmission, which is disposed as the load approaches or moves away, the condition imposed on the resonant switching collapses. Because when the condition imposed on the resonant switching collapses, a power loss, such as a loss in the FET, then increases rapidly, it is necessary to provide an exhaust heat device as a measure against the power loss. A further problem with the conventional technology is that the control of the waveform of the output voltage is not taken into consideration and an improvement in the efficiency of power transmission cannot be achieved.

The present invention is made in order to solve the above-mentioned problems, and it is therefore an object of the present invention to provide a resonant type high frequency power supply device that can maintain a condition imposed on the resonant switching with respect to variations in the impedance of the load and control the waveform of the output voltage, and that can operate at a high frequency exceeding 2 MHz.

### Means for Solving the Problem

In accordance with the present invention, there is provided a resonant type high frequency power supply device provided with a power element that performs a switching operation at a high frequency exceeding 2 MHz, the resonant type high frequency power supply device including a resonance matched filter that controls both the waveform of a switching voltage of the power element and the waveform of a device output voltage.

### Advantages of the Invention

Because the resonant type high frequency power supply device in accordance with the present invention is configured as above, the resonant type high frequency power supply device can maintain a condition imposed on the resonant switching with respect to variations in the impedance of the load and control the waveform of the output voltage, and can operate at a high frequency exceeding 2 MHz.

### BRIEF DESCRIPTION OF THE FIGURES

FIG. 1 is a diagram showing the configuration of a resonant type high frequency power supply device in accordance with Embodiment 1 of the present invention (in a case in which a power element has a single configuration);

FIGS. 2A and 2B are diagrams showing the waveform of Vds and the waveform of Vout of the resonant type high frequency power supply device in accordance with Embodiment 1 of the present invention;

FIG. 3 is a diagram showing another example of the configuration of the resonant type high frequency power supply device in accordance with Embodiment 1 of the present invention;

FIG. 4 is a diagram showing another example of the configuration of the resonant type high frequency power supply device in accordance with Embodiment 1 of the present invention;

FIG. 5 is a diagram showing another example of the configuration of the resonant type high frequency power supply device in accordance with Embodiment 1 of the present invention (in a case in which the power elements have a push-pull configuration);

FIG. 6 is a diagram showing another example of the configuration of the resonant type high frequency power supply device in accordance with Embodiment 1 of the present invention (in a case in which a variable resonance condition resonance matched filter is disposed);

FIG. 7 is a diagram showing another example of the configuration of the resonant type high frequency power supply device in accordance with Embodiment 1 of the present invention (in a case in which a variable resonance condition circuit is disposed); and

FIG. 8 is a diagram showing the configuration of a conventional resonant type high frequency power supply device.

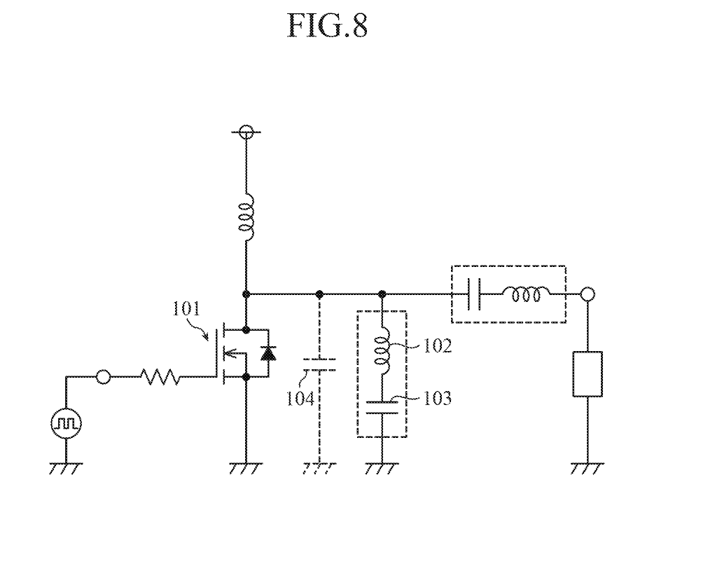

### EMBODIMENTS OF THE INVENTION

Hereafter, the preferred embodiments of the present invention will be explained in detail with reference to the drawings.

### Embodiment 1

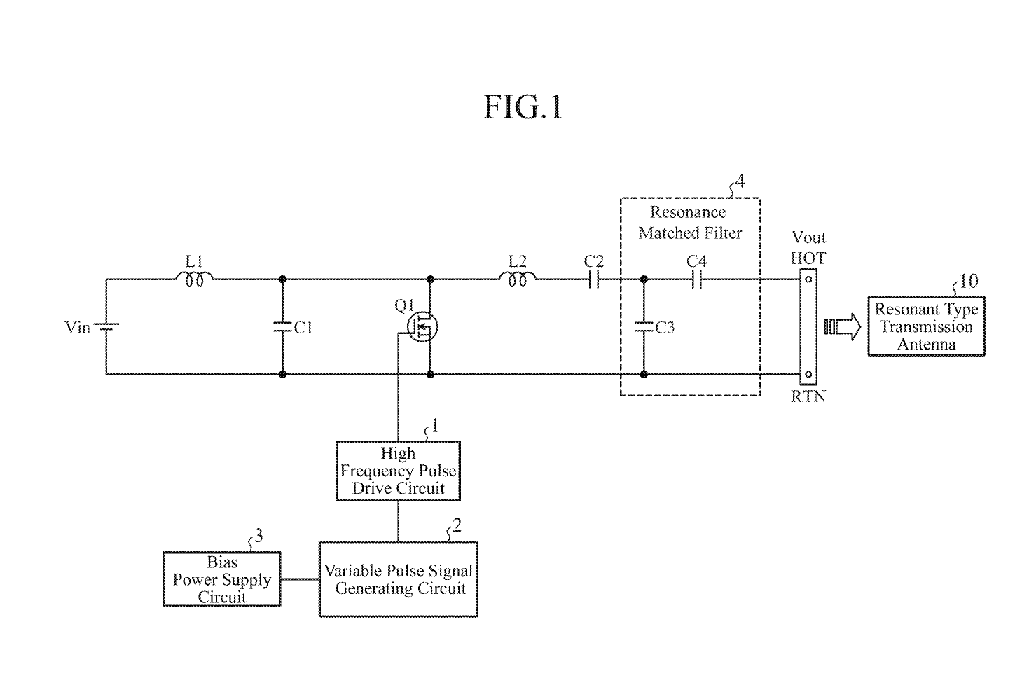

FIG. 1 is a diagram showing the configuration of a resonant type high frequency power supply device in accordance with Embodiment 1 of the present invention. In FIG. 1, a power element Q1 represents a circuit in a case of a single configuration.

The resonant type high frequency power supply device is comprised of the power element Q1, a resonance circuit element (capacitors C1 and C2 and an inductor L2), an inductor L1, a high frequency pulse drive circuit 1, a variable pulse signal generating circuit 2, a bias power supply circuit 3 and a resonance matched filter 4, as shown in FIG. 1.

A resonant type transmission antenna (a transmission antenna for power transmission) 10 is a resonant type antenna for power transmission having LC resonance characteristics (which is not limited only to a noncontact type one). This resonant type transmission antenna 10 can be of any of magnetic resonance type, electric resonance type, and electromagnetic induction type.

The power element Q1 is a switching element that performs a switching operation in order to convert a direct voltage Vin, which is an input, into an alternating voltage. As this power element Q1, not only an FET for RF but also an element, such as an Si-MOSFET, an SiC-MOSFET or a GaN-FET, can be used.

The resonance circuit element (the capacitors C1 and C2 and the inductor L2) is an element that causes the power element Q1 to perform resonant switching in the switching operation. By using this resonance circuit element which consists of the capacitors C1 and C2 and the inductor L2, the resonance condition can be matched to that of the resonant type transmission antenna 10.

The inductor L1 works to hold the energy of the DC input voltage Vin temporarily, every time when the power element Q1 performs the switching operation.

The high frequency pulse drive circuit 1 is a circuit that transmits a pulse-shaped voltage signal at a high frequency exceeding 2 MHz to a G terminal of the power element Q1, to drive the power element Q1. This high frequency pulse drive circuit 1 is a circuit which is provided a totem pole output circuit by using an FET or such a device to be able to perform a high-speed ON/OFF output.

The variable pulse signal generating circuit 2 is a circuit that transmits a pulse-shaped voltage signal having a high frequency exceeding 2 MHz, such as a logic signal, to the high frequency pulse drive circuit 1, to drive the high frequency pulse drive circuit 1. This variable pulse signal generating circuit 2 is comprised of an oscillator for frequency setting and logic ICs such as an inverter and a flip-flop, and has functions such as a function of changing a pulse width and a function of outputting reverse pulses.

The bias power supply circuit 3 supplies driving power to both the variable pulse signal generating circuit 2 and the high frequency pulse drive circuit 1.

The resonance matched filter 4 controls both the waveform of a switching voltage Vds of the power element Q1 and the waveform of an output voltage Vout of the resonant type high frequency power supply device. As a result, the output impedance of the resonance circuit element (the capacitors C1 and C2 and the inductor L2) can be matched to the input impedance of the resonant type transmission antenna 10 which is the load side.

Next, the operation of the resonant type high frequency power supply device configured as above will be explained.

First, the input direct voltage Vin is applied to a D terminal of the power element Q1 through the inductor L1. The power element Q1 then converts the voltage into a positive voltage in an alternating form by performing the ON/OFF switching operation. At the time of this conversion operation, the inductor L1 works to hold the energy temporarily, thereby helping the conversion of the direct voltage to the alternating voltage.

In this embodiment, in the switching operation of the power element Q1, in order to minimize a switching loss due to the product of an Ids current and a Vds voltage, the resonant switching condition is set to conduct a ZVS (zero voltage switching) to the resonance circuit device which consists of the capacitors C1, C2 and the inductor L2. By performing this resonant switching operation, the alternating voltage centered on an RTN voltage is outputted as an output voltage Vout.

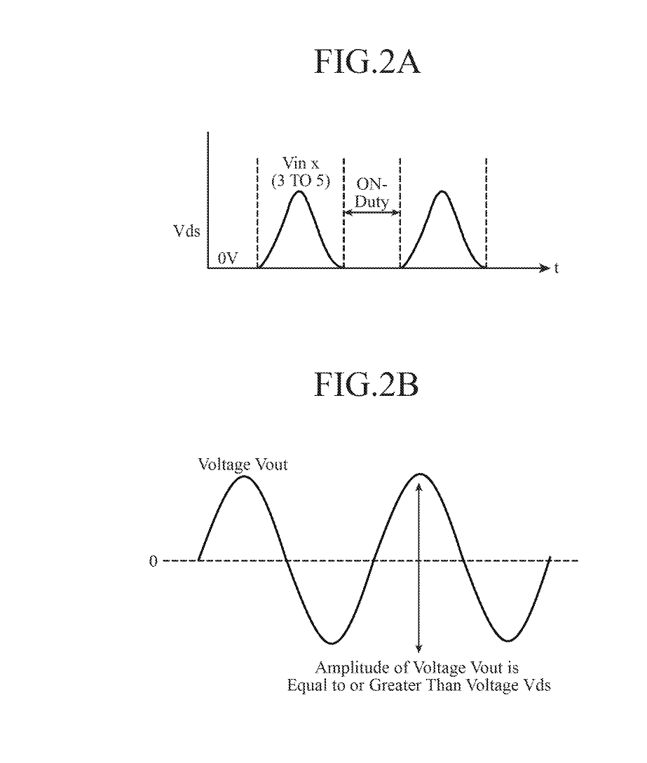

At that time, because a relation between the switching voltage Vds of the power element Q1 and the output voltage Vout is set by the resonance matched filter 4, the resonant switching condition of the internal circuit does not change with a change in the impedance of the load side. The constants of the resonance matched filter 4 are set in such a way that the waveforms of the voltages Vds and Vout satisfy such conditions as shown in FIGS. 2A and 2B. Referring to FIG. 2A, the resonance matched filter operates with an on-duty ranging from 30% to 80%.

The driving of the power element Q1 is performed by inputting the pulse-shaped voltage signal, which the high frequency pulse drive circuit 1 which has received the arbitrary pulse-shaped voltage signal from the variable pulse signal generating circuit 2 outputs, to the G terminal of the power element Q1. At that time, the driving frequency of the power element Q1 serves as the operating frequency of the resonant type high frequency power supply device, and is determined by a setting made on the oscillator circuit disposed in the variable pulse signal generating circuit 2.

As mentioned above, because the resonant type high frequency power supply device in accordance with this Embodiment 1 is configured in such a way as to include the resonance matched filter 4 that controls both the waveform of the switching voltage Vds of the power element Q1 and the waveform of the output voltage Vout, the resonant type high frequency power supply device can maintain the condition imposed on the resonant switching with respect to variations in the impedance of the load (does not cause the condition imposed on the resonant switching to deviate by 50% or more) and control the waveform of the output voltage Vout in the operation at a high frequency exceeding 2 MHz.

As a result, even if an impedance component having a resonance condition, such as an antenna for wireless power transmission, which is disposed as the load approaches or moves away, no heat generation occurs due to a rapid power loss, and therefore it is not necessary to perform excessive design of exhaust heat such as provision of a heat sink for prevention of heat generation. Therefore, a cost reduction, downsizing, a weight reduction, and high efficiency can be achieved.

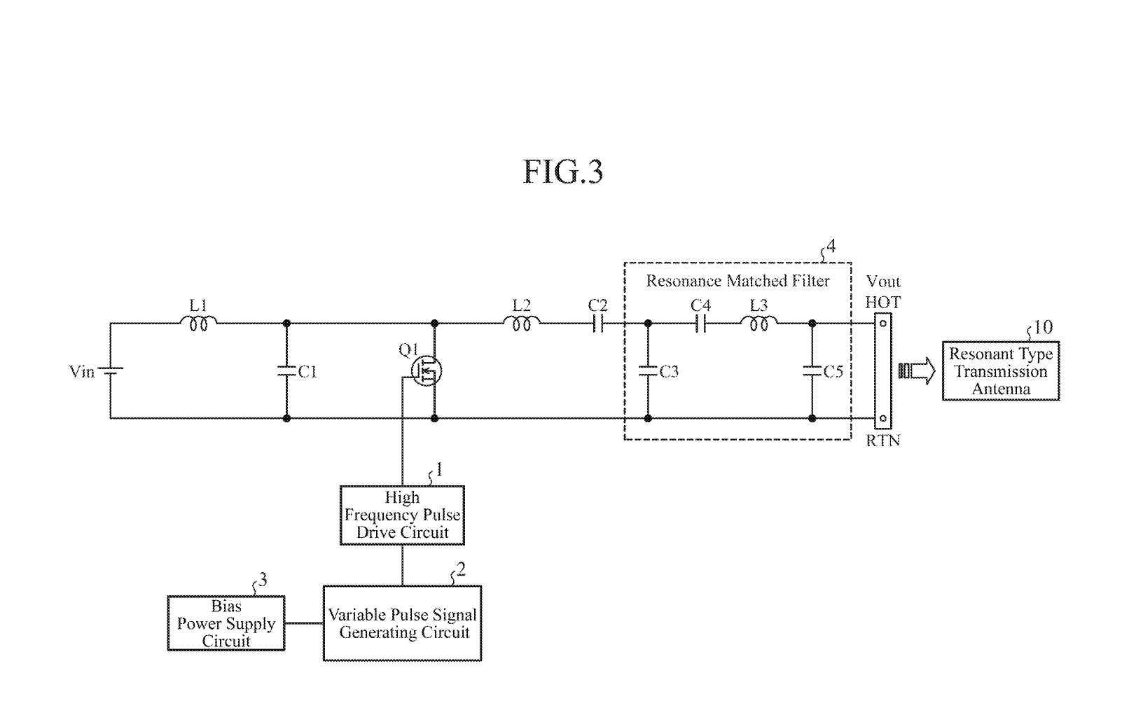

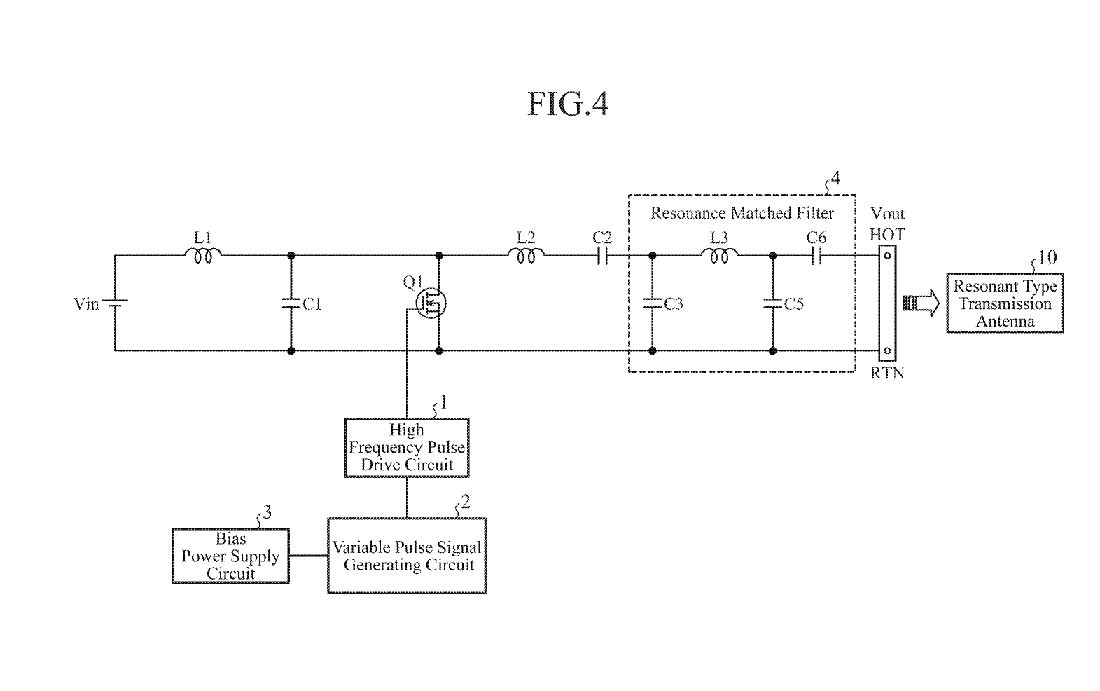

Although the case in which the resonance matched filter 4 which consists of the capacitors C3 and C4 is used is shown in FIG. 1, this embodiment is not limited to this example. For example, the resonance matched filter 4 having such a configuration as shown in FIG. 3 or 4 can be alternatively used.

Further, although the case in which the high frequency pulse drive circuit 1, the variable pulse signal generating circuit 2 and the bias power supply circuit 3 are used in order to drive the power element Q1 is shown in FIG. 1, this embodiment is not limited to this example. For example, a drive circuit of transformer type, an RF power amplifier circuit and a multi-output power supply circuit can be alternatively used.

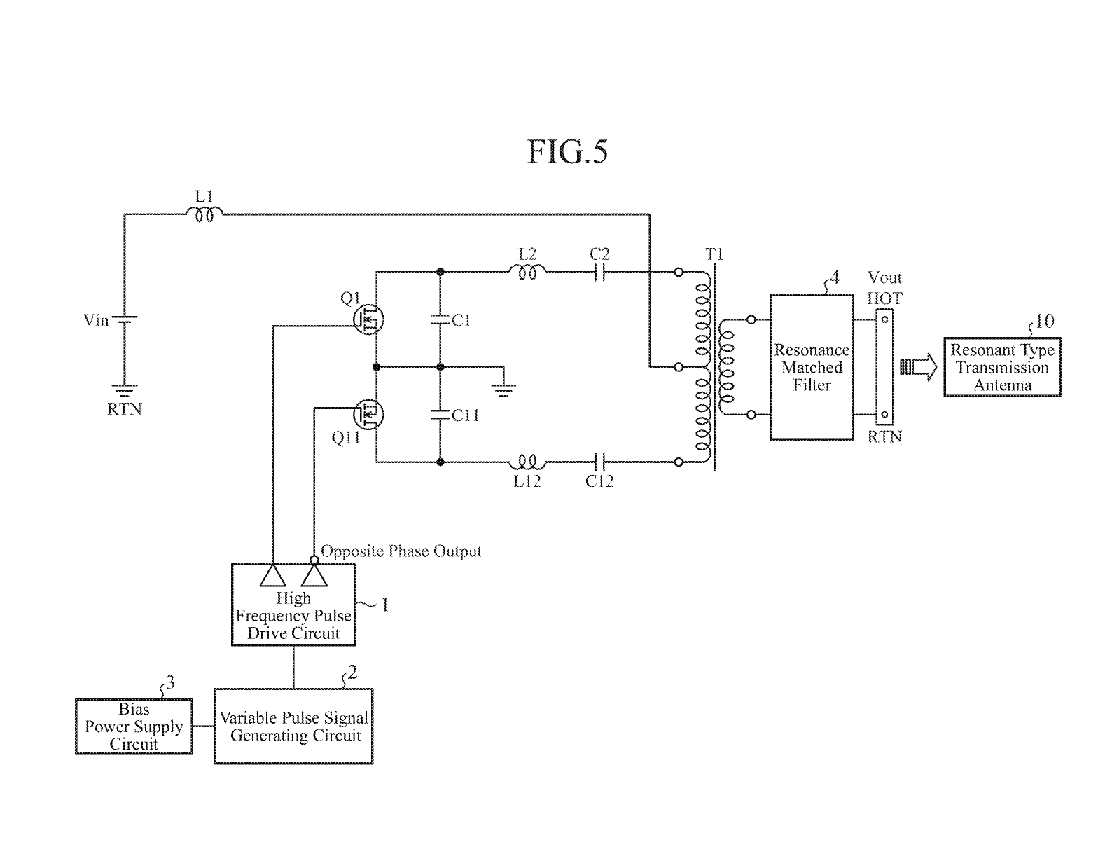

Further, although the circuit in the case in which the power element Q1 has a single configuration is shown in FIG. 1, this embodiment is not limited to this example. For example, as shown in FIG. 5, the present invention can be similarly applied to a case in which the power element Q1 has a push-pull configuration.

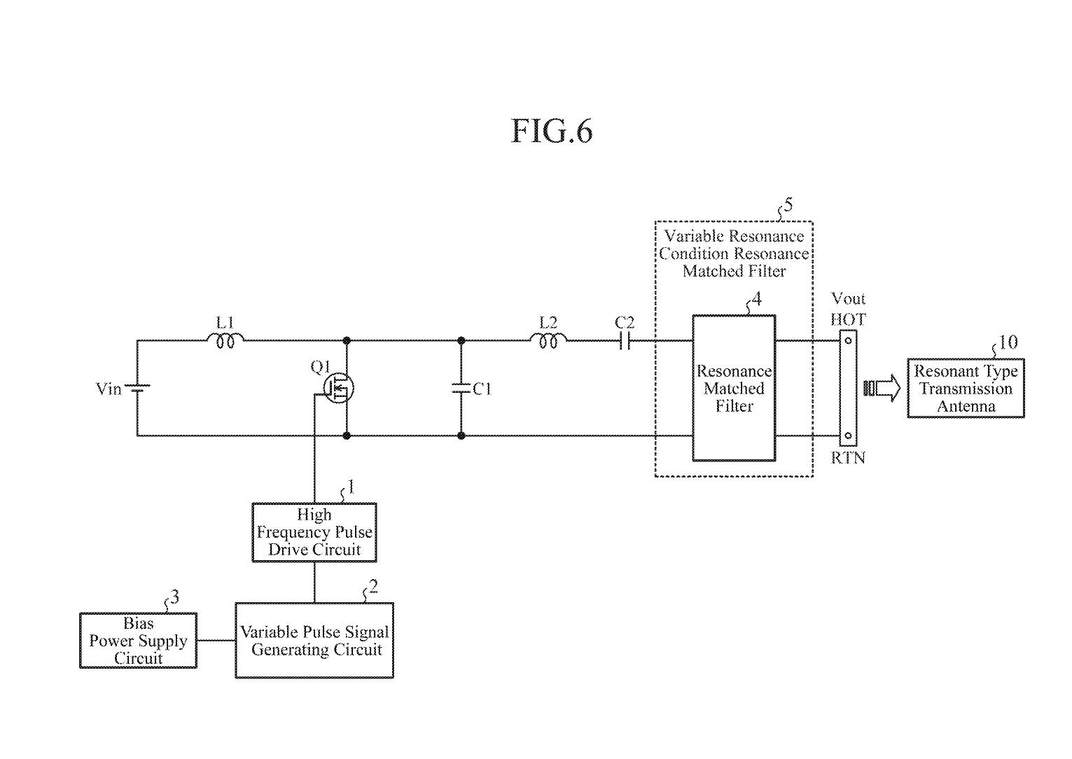

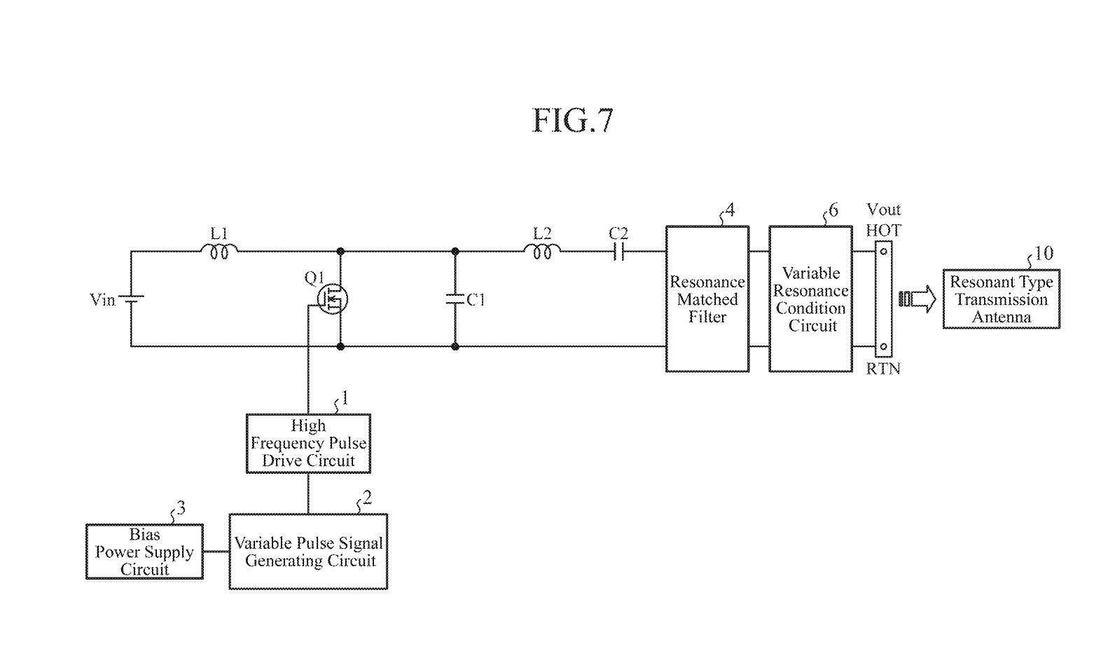

Further, although the case in which the resonance condition according to the resonance circuit element is fixed is explained in FIG. 1, this embodiment is not limited to this example. For example, as shown in FIG. 6, a variable resonance condition resonance matched filter 5 that causes the resonance condition according to the resonance circuit element to be variable can be alternatively used. Further, for example, as shown in FIG. 7, a variable resonance condition circuit 6 that causes the resonance condition according to the above-mentioned resonance circuit element (the capacitors C1 and C2 and the inductor L2) to be variable can be disposed separately.

Further, while the invention has been described in its preferred embodiment, it is to be understood that various changes can be made in an arbitrary component in accordance with the embodiment, and an arbitrary component in accordance with the embodiment can be omitted within the scope of the invention.

### INDUSTRIAL APPLICABILITY

The resonant type high frequency power supply device in accordance with the present invention can maintain the condition imposed on the resonant switching with respect to variations in the impedance of the load and control the waveform of the output voltage, and can operate at a high frequency exceeding 2 MHz, and is suitable for use as a resonant type high frequency power supply device or the like that performs power transmission at a high frequency.

### EXPLANATIONS OF REFERENCE NUMERALS

1 high frequency pulse drive circuit, 2 variable pulse signal generating circuit, 3 bias power supply circuit, 4 resonance matched filter, 5 variable resonance condition resonance matched filter, 6 variable resonance condition circuit, and 10 resonant type transmission antenna (transmission antenna for power transmission).

1. A resonant type high frequency power supply device provided with a power semiconductor element that performs a switching operation at a high frequency exceeding 2 MHz, said resonant type high frequency power supply device comprising:
a resonance matched filter that controls both a waveform of a switching voltage of said power semiconductor element and a waveform of a device output voltage.

2. The resonant type high frequency power supply device according to claim 1, wherein said power semiconductor element is an FET (Field Effect Transistor) other than an FET for RF (Radio Frequency).

3. The resonant type high frequency power supply device according to claim 1, wherein said power semiconductor element has a push-pull configuration or a single configuration.

4. The resonant type high frequency power supply device according to claim 1, wherein said resonant type high frequency power supply device includes a resonance circuit element that matches a resonance condition to that of a transmission antenna for power transmission according to magnetic resonance and that is comprised of a capacitor and an inductor.

5. The resonant type high frequency power supply device according to claim 1, wherein said resonant type high frequency power supply device includes a resonance circuit element that matches a resonance condition to that of a transmission antenna for power transmission according to electric resonance and that is comprised of a capacitor and an inductor.

6. The resonant type high frequency power supply device according to claim 1, wherein said resonant type high frequency power supply device includes a resonance circuit element that matches a resonance condition to that of a transmission antenna for power transmission according to electromagnetic induction and that is comprised of a capacitor and an inductor.

7. The resonant type high frequency power supply device according to claim 4, wherein said resonance matched filter causes the resonance condition of said resonance circuit element to be variable.

8. The resonant type high frequency power supply device according to claim 5, wherein said resonance matched filter causes the resonance condition of said resonance circuit element to be variable.

9. The resonant type high frequency power supply device according to claim 6, wherein said resonance matched filter causes the resonance condition of said resonance circuit element to be variable.

10. The resonant type high frequency power supply device according to claim 4, wherein said resonant type high frequency power supply device includes a variable resonance condition circuit that causes the resonance condition of said resonance circuit element to be variable.

11. The resonant type high frequency power supply device according to claim 5, wherein said resonant type high frequency power supply device includes a variable resonance condition circuit that causes the resonance condition of said resonance circuit element to be variable.

12. The resonant type high frequency power supply device according to claim 6, wherein said resonant type high frequency power supply device includes a variable resonance condition circuit that causes the resonance condition of said resonance circuit element to be variable.
